(19) United States
(12) Patent Application Publication
(10) Pub. No.: US 2009/0125901 A1
(43) Pub. Date: May 14, 2009

(54) Providing virtualization of a server management controller

(76) Inventor: Robert C. Swanson, Olympia, WA (US)

Correspondence Address: TROP, PRUNER & HU, P.C., 1616 S. VOSS RD., SUITE 750, HOUSTON, TX, 77057-2631, US

(21) Appl. No.: 11/983,889

(22) Filed: Nov. 13, 2007

(51) Int. Cl. G06F 9/455

(52) U.S. Cl. 718/1

(57) ABSTRACT

In one embodiment, the present invention includes a method for creating a virtual machine (VM) in a server platform having a baseboard management controller (BMC) and enabling the VM to virtualize the BMC, receiving a request in the VM for performing a BMC function in the VM, initiating a communication from the VM to the BMC, and trapping the communication in management software of the server platform and routing the communication to a predetermined port of the BMC. Other embodiments are described and claimed.

### BACKGROUND

Server systems are used in many different areas such as datacenters. As such systems provide increasing amounts of computing capabilities, efforts are being made to further extend these hardware benefits using virtualization. Generally, virtualization techniques are used to enable multiple so-called virtual machines (VMs) each to appear as a complete and independent computing resource, although multiple VMs may share only a single set of underlying platform hardware.

Current virtual machine monitors (VMMs) only spawn virtual machines that are simple systems like a simple desktop or simple management-less server. In doing so, they do not utilize many important server features like Intelligent Platform Management Interface (IPMI), which is the dominant server management solution in the server industry today and for the foreseeable future. Many servers include baseboard management controllers (BMCs), which are multithreaded controllers that communicate with the host operating system (OS), platform drivers, applications, and basic input/output system (BIOS) via keyboard controller style (KCS) input/output (IO) ports. These BMCs handle each interface with a dedicated thread.

The simple virtual machines available on a server system cannot achieve operations such as remote monitoring, field replacement unit monitoring, system event logging, and so forth. As such, their use can be somewhat limited.

### BRIEF DESCRIPTION OF THE DRAWINGS

FIG. 1 is a block diagram of a system in accordance with an embodiment of the present invention.

FIG. 2 is a flow diagram of a method in accordance with one embodiment of the present invention.

FIG. 3 is a block diagram of a chassis server system in accordance with an embodiment of the present invention.

### DETAILED DESCRIPTION

In various embodiments, virtual machines provided for use in server environments may be extended to enable virtualization of management controller resources such as baseboard management controllers (BMCs). Furthermore, such virtualization may be provided for other controllers such as chassis management modules (CMMs) and so forth. In this way, virtual machines created for a given server platform may be used to perform various management, remote control, logging and other such operations. In one embodiment, a VMM may create child VMs that include embedded codes so each VM appears as if it had a local IPMI compliant BMC. In one embodiment, such codes may include a server management BIOS (SMBIOS) table record type 38 (embedded controller), Advanced Configuration and Power Interface (ACPI) code, etc. While the scope of the present invention is not limited in this regard, the input/output (IO) address that the VMM exposes via SMBIOS and ACPI interfaces may be either 0xCA2 or 0xCA4. Alternatively, the VMM may use virtualization technology and use an IO address of 0x90. Thus the VMM or a VM delegate could trap IO requests to these addresses and appropriately route the communication to the appropriate BMC communication port.

In this way, a single IPMI-compliant BMC can support multiple VMs such that the OS and applications running on the virtual machine can have full IPMI and server manageability features like field-replaceable unit (FRU) inventory/storage, system event logging, and so forth. In other words utilizing embodiments of the present invention, servers with BMC's can create virtual machines that look, act, and behave like an IPMI compliant server.

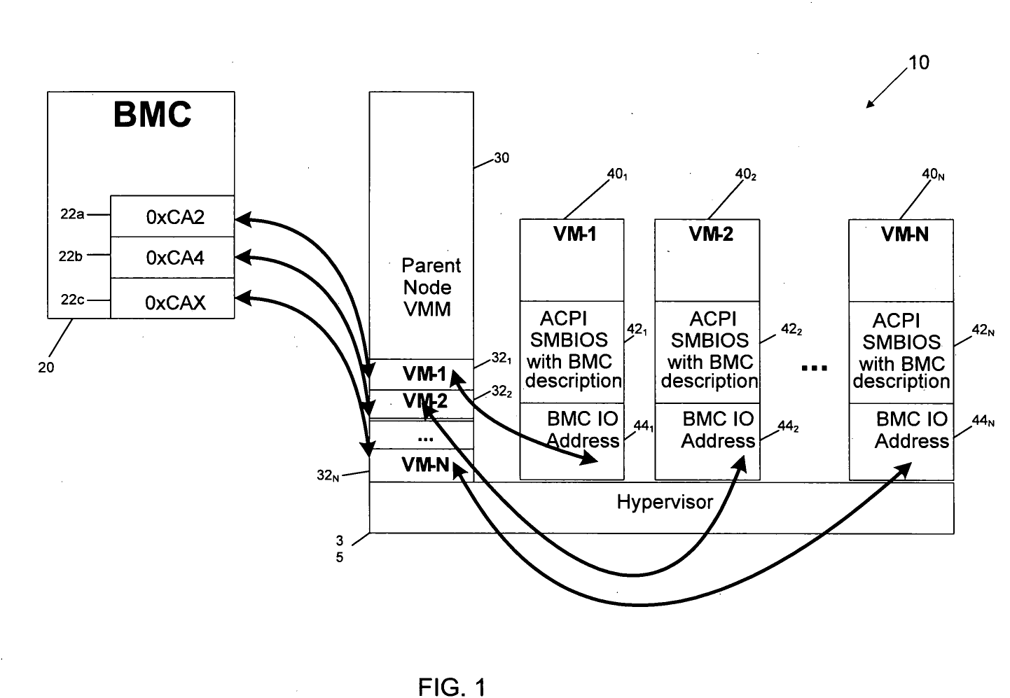

Referring now to FIG. 1, shown is a block diagram of a system in accordance with an embodiment of the present invention. As shown in FIG. 1, system 10 may be a server system that shows certain hardware aspects, as well as their interactions with certain software components. Specifically, as shown in FIG. 1 system 10 includes a baseboard management controller (BMC) 20 that includes multiple IO ports, namely ports 22a-22c (generically port 22), each of which has an independently addressable port address.

FIG. 1 further shows a hypervisor 35, which may correspond to virtualization management software to control generation of virtual machines and their configuration. Furthermore, a VMM 30 may be present, which may act as a parent node to provide communication via virtualized addresses 32₁-32ₙ (generically addresses 32), which may be included in a table to map VMs to virtualized addresses, which in turn can be mapped to ports 22. In some embodiments, hypervisor 35 may initiate VMM 30. Note that in some implementations VMM 30 and hypervisor 35 may be separate components, while in other implementations such components may be integrated into a single unit.

As further shown in FIG. 1, hypervisor 35 (and/or prevent node VMM 30) may also instantiate a plurality of virtual machines 40₁-40ₙ (generically VM 40). Each VM 40 can have dedicated IO resources like network interface cards (NICs) and communicate remotely with server management application software or communicate natively to the OS installed on the VM (not shown in FIG. 1). As further shown in FIG. 1, each VM 40 includes a corresponding server management BIOS (SMBIOS) 42₁-42ₙ (generically SMBIOS 42). Such SMBIOS 42 may further include ACPI tables, in addition to the SM tables and other configuration data. Furthermore, such code may include a description of the corresponding virtual BMC and other hardware. To enable communication between the virtual BMCs and the underlying hardware of BMC 20, each VM 40 may include a virtual IO address 44₁-44ₙ (generically virtual IO address 44). When IPMI communication occurs, the server management software will utilize the IO address defined in the SMBIOS and ACPI tables (i.e., virtual IO address 44) to communicate with the “local”, i.e., virtualized BMC 20.

In some implementations, parent node VMM 30 may act to perform requests received from a VM 40 and directed to BMC 20, if it has the capability to do so. For example, certain requests such as requests for providing configuration information, system reset, FRU device data and so forth may be handled in parent node VMM 30. In this way, when the communication is trapped by parent node VMM 30, it may determine that it has the capability and handle the request and then provide communication back to the requesting VM 40. If instead, it lacks the capability to handle the request, it may forward the request to a given port 22 based on address 32 within a table of parent node VMM 30 associated with a given VM 40. Thus when virtual IO address 44 is written the parent node VMM 30, it can handle the IPMI request itself, or if not, if can direct the IPMI request to any of the KCS IPMI IO addresses (i.e., ports 22 of BMC 20) or postpone the IPMI communication. Further, if communication with the BMC 20 on the channel becomes unstable, parent node VMM 30 can stop communication and either choose to restart the VM 40 or restart IPMI communication with a different port. If a BMC port 22 becomes unstable the parent node VMM 30 can choose to only use another port and/or order communications from VMs 40 to BMC 20 based on the VMs priority or current requirements. While described with this particular implementation in the embodiment of FIG. 1, the scope of the present invention is not limited in this regard.

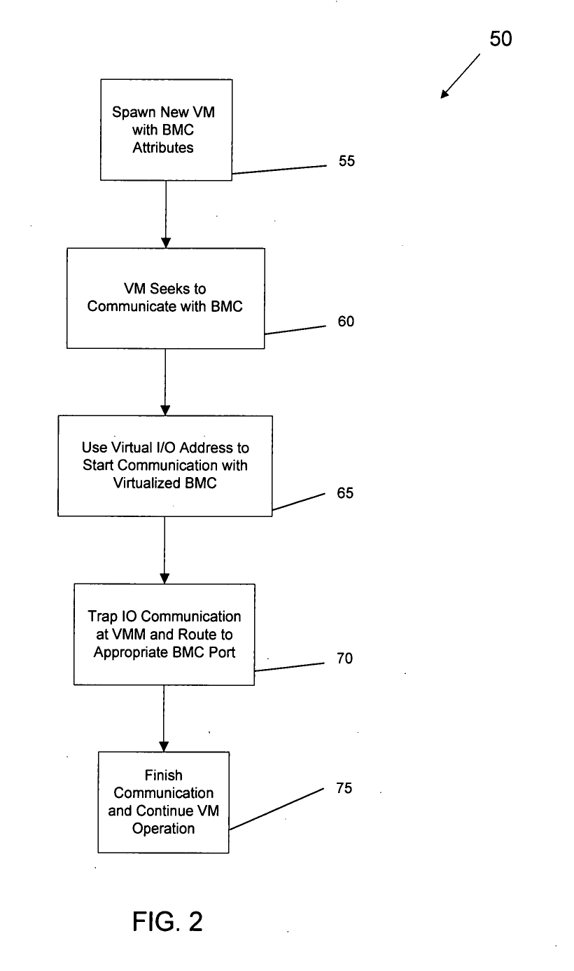

Referring now to FIG. 2, shown is a flow diagram of a method in accordance with one embodiment of the present invention. As shown in FIG. 2, method 50 may be used to create and use virtual management controllers, such as BMCs in a server platform. As shown in FIG. 2, method 50 may begin by spawning a new VM with BMC attributes (block 55). For example, a VMM may generate one or more VMs, each of which includes its own guest OS and guest software such as various application programs and so forth. Furthermore, to enable BMC virtualization, various configuration codes and tables such as ACPI and SMBIOS tables may be generated to include a description of the BMC hardware to be virtualized, along with providing a virtual IO address for communication between the VM and a VMM, hypervisor, or directly to a BMC. Thus a VMM may spawn one or more child virtual machines that appear to remote applications (and their guest OSs) as fully functional IPMI-compliant servers.

Thus using embodiments of the present invention, true server virtualization may be realized. In a data center environment, each server may be virtualized into multiple true virtual machine copies, enabling true redundancy of an IPMI-based server, each of which has a virtual BMC or other such management controller hardware.

After such initialization is performed, the server including the one or more VMs may then operate in a normal configuration. During execution, due to an internal or external request, the VM may desire to communicate with the BMC (block 60). To enable such communication, the BMC may use the virtual IO address exposed via the configured tables/software (e.g., ACPI/SMBIOS) to start communication with the virtualized BMC (block 65). Accordingly, communication may be initiated from the corresponding VM to a parent node VMM, hypervisor or other such management software. Thus as shown at block 70, the VMM may trap this IO communication. If the VMM is capable of handling the associated request, it may do so, and control passes to block 70, otherwise the VMM may route the request to the appropriate port of the BMC. More specifically, the parent node can direct the communication, which may be an IPMI request, to a predetermined IO port of the BMC. For example, each VM instantiated may be associated with a given IO port as its primary port. Of course, secondary mappings of virtual machines to secondary ports may also be provided. While not shown in FIG. 2, if problems occur with this port, the parent node VMM can reroute the communication via a different port of the BMC. For example, the communication from the VM can be directed to a dedicated interface, i.e., port of the BMC or multiple VMs may be associated with a single port, and the parent node VMM can order these requests based on the importance of the communications or the job of the virtual machines. If a communication fails, the parent node VMM can either choose to restart the VMM or restart the communication via a different port on the BMC.

As further shown in FIG. 2, from block 70 control passes to block 75, where the communication concludes and the VM may continue its operation. Thus the BMC may perform a BMC operation in the BMC responsive to the communication and forward a result of the BMC operation to the VM through the parent node VMM. While shown with this particular implementation in the embodiment of FIG. 2, the scope of the present invention is not limited in this regard. Thus using embodiments such as FIG. 2, different virtual machines may be provided with a BMC or other management controller hardware in virtualized form, and communication between the VMs and the BMC may occur under intermediate control of the VMM or other management software.

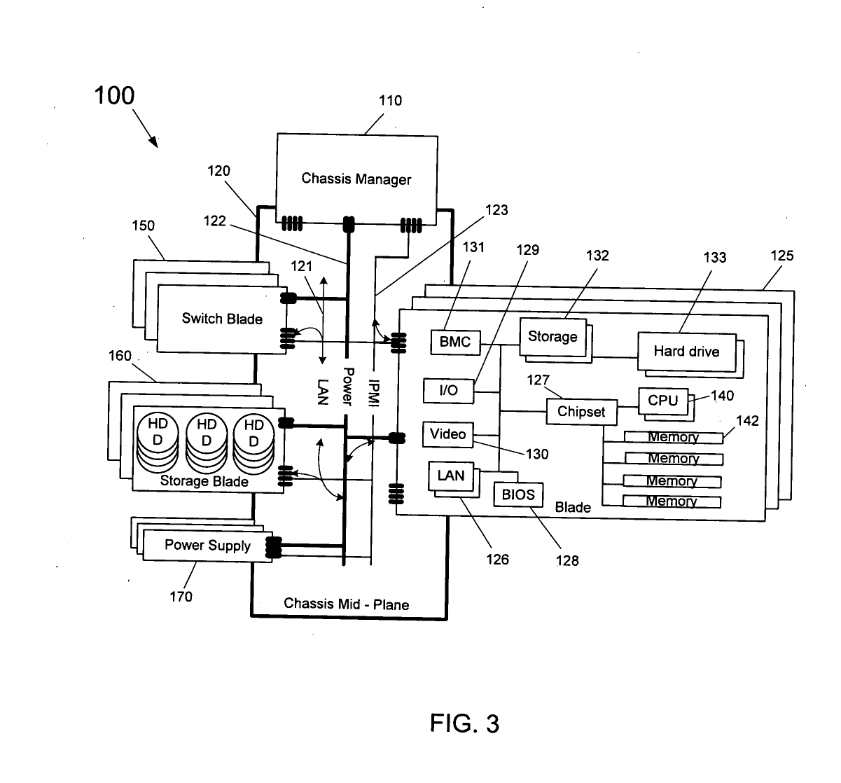

Referring now to FIG. 3, shown is a block diagram of a chassis server in accordance with an embodiment of the present invention. As shown in FIG. 3, chassis 100 includes a chassis manager 110 coupled to a chassis mid-plane 120 to which a plurality of blades 125 are coupled (which may be heterogeneous blades), e.g., by LAN connections 121, power connections 122, and IPMI connections 123. For example, one such blade 125 includes a local area network (LAN) controller 126 coupled to a bus that is coupled to various computer resources such as a chipset 127, a BIOS storage 128 and other devices such as IO device 129, a video device 130, a BMC 131, storage devices 132, which in turn may be coupled to hard drives 133. In turn, chipset 127 is coupled to a central processing unit (CPU) 140 and plurality of memory modules, namely memory 142, which may be one dual in-line memory module (DIMM) of a plurality of such modules.

As further shown in FIG. 3 chassis mid-plane 120 may be coupled to a plurality of switch blades 150, a plurality of storage blades 160 and a power supply 170. In the embodiment of FIG. 3, the various blades may include heterogeneous resources and may originate from different vendors. Thus chassis 100 may be an open blade rack with different blades. In one such embodiment, each blade 125 may be configured with a VMM that in turn instantiates multiple VMs, each of which associated with a different operating system (OS) for example, of different vendors. While shown with this particular implementation in the embodiment of FIG. 3, the scope of the present invention is not limited in this regard.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
creating a virtual machine (VM) in a server platform having a baseboard management controller (BMC), the VM including attributes of the BMC and a virtual input/output (IO) address to enable the VM to virtualize the BMC;
receiving a request in the VM for performing a BMC function in the VM;
initiating a communication from the VM to the BMC using the virtual 10 address; and
trapping the communication in management software of the server platform and routing the communication to a predetermined port of the BMC.

2. The method of claim 1, further comprising creating the virtual machine using a parent node virtual machine monitor (VMM) instantiated by a hypervisor, trapping the communication in the parent node VMM, and handling the request associated with the communication in the parent node VMM if possible, otherwise routing the communication to the predetermined port of the BMC.

3. The method of claim 1, further comprising performing a BMC operation in the BMC responsive to the communication and forwarding a result of the BMC operation to the VM through the management software.

4. The method of claim 3, further comprising receiving a plurality of communications in the management software from a plurality of virtual machines, and routing the plurality of communications to the predetermined port of the BMC in an order corresponding to a priority of each of the plurality of communications.

5. The method of claim 4, further comprising routing at least one of the communications to the BMC to a different port than the predetermined port if a failure occurs during the communication to the predetermined port.

6. The method of claim 1, wherein the BMC attributes include a description of the BMC set forth in a system management basic input/output system (BIOS) table of the VM.

7. The method of claim 6, further comprising receiving the request in the VM from a guest operating system of the VM.

8. The method of claim 6, further comprising receiving the request in the VM remotely from a server management application.

9. A system comprising:
a processor to create a second virtual machine (VM) including attributes of a baseboard management controller (BMC) of the system and a virtual input/output (IO) address to enable the second VM to virtualize the BMC, initiate a communication from the second VM to the BMC using the virtual IO address, trap the communication in a first VM and handle a request associated with the communication in the first VM if the first VM can support the request, otherwise route the communication from the first VM to a predetermined port of the BMC; and
the BMC coupled to the processor to perform intelligent platform management interface (IPMI) operations and to communicate with the second VM via the first VM.

10. The system of claim 9, wherein the processor is to execute a hypervisor to instantiate the first VM including a parent node IO address to communicate with the second VM and the BMC via the virtual IO address.

11. The system of claim 10, wherein the system is to perform a BMC operation in the BMC responsive to the communication and forward a result of the BMC operation to the second VM through the first VM.

12. The system of claim 11, wherein the system is to receive a plurality of communications in the first VM from a plurality of second virtual machines, and route the plurality of communications to the predetermined port of the BMC in an order corresponding to a priority of each of the plurality of communications.

13. An article comprising a machine-accessible medium including instructions that when executed cause a system to:
create a virtual machine (VM) including attributes of a baseboard management controller (BMC) of the system and a virtual input/output (IO) address to enable the VM to virtualize the BMC;
receive a request in the VM for performing a BMC function;
initiate a communication including the request from the VM to the BMC using the virtual IO address; and
trap the communication in management software and route the communication to a predetermined port of the BMC for handling if the management software cannot handle the request.

14. The article of claim 13, wherein the instructions further enable the system to perform a BMC operation in the BMC responsive to the request and forward a result of the BMC operation to the VM through the management software.

15. The article of claim 13, wherein instructions further enable the system to receive a plurality of communications in the management software from a plurality of virtual machines, route the plurality of communications to the predetermined port of the BMC in an order corresponding to a priority of each of the plurality of communications, and route at least one of the communications to a different port of the BMC than the predetermined port if a failure occurs during the communication to the predetermined port.
